(19) United States
(12) Patent Application Publication
(10) Pub. No.: US 2009/0217161 A1
(43) Pub. Date: Aug. 27, 2009

(54) Apparatus system and method of print processing

(75) Inventor: Youichi Minegishi, Sagamihara-shi (JP)

Correspondence Address: HARNESS, DICKEY & PIERCE, P.L.C., P.O. BOX 8910, RESTON, VA, 20195, US

(73) Assignee: RICOH COMPANY, LTD.

(21) Appl. No.: 12/379,443

(22) Filed: Feb. 23, 2009

(30) Foreign Application Priority Data
Feb. 25, 2008 (JP) 2008-043655

(51) Int. Cl. G06F 17/00

(52) U.S. Cl. 715/274; 719/321

(57) ABSTRACT

An apparatus, system, and method of print processing are provided, each capable of generating an image according to print settings information using a primary user interface device and an added user interface device. The added user interface device generates an added image when a current condition specified by current processing status information satisfies an image generation condition, and sends the added image to the primary user interface device.

### CROSS-REFERENCE TO RELATED APPLICATIONS

This patent application is based on and claims priority under 35 U.S.C. § 119 to Japanese Patent Application No. 2008-043655, filed on Feb. 25, 2008, in the Japanese Patent Office, the disclosure of which is hereby incorporated herein by reference.

### FIELD OF THE INVENTION

The present invention generally relates to an apparatus, system, and method of print processing, and more specifically to an apparatus, system, and method of generating data to be displayed through a user interface according to print settings information.

### BACKGROUND

In order to add functionality of an application program that runs on an operating system installed on a computer, a plug-in (“plugin”) may be provided. For example, as described in U.S. Pat. No. 7,284,246, patented on Oct. 16, 2007, a plugin module may be provided, which adds a new function to a device driver such as a printer driver.

In order to allow a user to select the new function that has been added, an image that corresponds to the new function provided by the plugin may be displayed to the user in addition to an image that corresponds to the basic function of the device driver.

In one example, the plugin performs operation of drawing an image corresponding to the new function before the device driver performs operation of drawing or after the device driver performs operation of drawing. The image drawn by the plugin and an image drawn by the device driver are combined into a combined image for display. For example, as illustrated in FIG. 1, a printer driver user interface (UI) section 1 and a plugin user interface (UI) 2 section are provided, each of which operates on an operating system (OS).

At S1, the printer driver UI section 1 receives an instruction for displaying a user interface such as a print property dialog. At S2, the printer driver UI section 1 sends notification to the plugin UI section 2 to cause the plugin UI section 2 to start operation of drawing an image corresponding to the new function provided by the plugin. At S3, the plugin UI section 2 draws an image corresponding to the new function. At S4, the printer driver UI section 1 draws an image according to print settings information that is set through the printer property dialog. At S5, the printer driver UI section 1 sends notification to the plugin UI section 2, which indicates that drawing is completed. At S6, the plugin UI section 2 draws an image corresponding to the new function. The images that have been generated are combined into a combined image in the order of which the images are generated.

The above-described method of drawing data may sometimes cause a resultant image to contradict with the print settings information. For example, as illustrated in FIG. 2A, it is assumed that the plugin UI section 2 firstly draws a watermark image corresponding to the new function of generating a watermark. After the plugin UI section 2 draws the watermark image, the printer driver UI section 2 draws a sheet image, a text image, and a duplex printing image. Since the images that have been generated are combined into a combined image of FIG. 2B in the order of which the images are generated, the resultant combined image of FIG. 2B does not show the watermark image generated by the plugin UI section 2.

In another example, the plugin performs operation of drawing an image corresponding to the new function as well as operation of drawing an image corresponding to the basic function provided by the device driver. For example, as illustrated in FIG. 3, a printer driver UI section 3 including a drawings section 4, and a plugin UI section 5 including a drawing section 6 and an extended drawing section 7 are provided. When the plugin is not implemented, as indicated by the arrow 8 of FIG. 3, the drawing section 4 of the printer driver UI section 3 performs operation of drawing. When the plugin UI section 5 is implemented, as indicated by the arrow 9 of FIG. 3, the drawing section 6 of the plugin UI section 5 performs operation of drawing. In this example, the drawing section 6 may perform operation of drawing according to information regarding the layout structure or drawing, which may be stored in the extended drawing section 122.

The above-described method of drawing data is not efficient as the drawing section 4 of the printer driver UI section 3 becomes ineffective when the plugin is added. Further, the above-described method of drawing data is not applicable to the case where more than one plugin is added.

### SUMMARY

Example embodiments of the present invention include a print processing apparatus including a primary user interface to obtain a plurality of printing parameters from print settings information and to generate an image to be output using the plurality of printing parameters; and an added user interface device being installed after installation of the primary user interface device and to provide an added image to the primary user interface device when the added image corresponds to one of the plurality of printing parameters. The primary user interface device includes a notifying section to send notification to the added user interface device. The notification includes current processing status information indicating whether an image corresponding to any one of the plurality of printing parameters is generated. The added user interface device includes a drawing rule processor and a notifying section. The drawing rule processor is caused to obtain drawing rule information specifying a condition of which the added image is to be generated by the added user interface device, to determine whether a current condition specified at least by the current processing status information obtained from the notification being sent from the primary user interface device satisfies the condition of which the added image is to be generated to generate a determination result, and to generate the added image when the determination result indicates that the current condition satisfies the condition of which the added image is to be generated. The notifying section sends notification to the primary user interface device in response to the notification being received from the primary user interface device. The notification includes current processing status information indicating whether the added image is generated.

Example embodiments of the present invention include a method of generating an image to be used for print processing. The method includes: installing a primary user interface device onto a print processing apparatus; installing an added user interface device onto the print processing apparatus after installation of the primary user interface device; receiving, through an input device, a user input including print settings information; obtaining, by the primary user interface device, a plurality of printing parameters from the print settings information; sending notification from the primary user interface device to the added user interface device, the notification including current processing status information indicating whether an image corresponding to any one of the plurality of printing parameters is generated; obtaining, by the added user interface device, drawing rule information specially created for the added user interface device, the drawing rule information specifying a condition of which the added image is to be generated by the added user interface device; determining, by the added user interface device, whether a current condition specified at least by the current processing status information obtained from the notification being sent from the primary user interface device satisfies the condition of which the added image is to be generated to generate a determination result; generating the added image when the determination result indicates that the current condition satisfies the condition of which the added image is to be generated; and sending notification from the added user interface device to the primary user interface device in response to the notification being received from the primary user interface device, the notification including current processing status information indicating whether the added image is generated.

In addition to the above-described example embodiments, the present invention may be practiced in various other ways, for example, as a print processing system including the above-described print processing apparatus or a recording medium storing instructions which cause a computer to carry out the above-described method.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a data flow diagram illustrating operation of drawing a plurality of images according to print settings information, performed by a printer driver and a plugin, using a background technique;

FIG. 2A is an illustration for explaining the order in which the plurality of images are generated, when the background technique of FIG. 1 is used;

FIG. 2B is an illustration for explaining a combined image generated by combining the plurality of images generated by the printer driver and the plugin, when the background technique of FIG. 2 is used;

FIG. 3 is a schematic block diagram illustrating operation of drawing a plurality of images according to print settings information, performed by a printer driver and a plugin, using a background technique;

FIG. 4 is a schematic block diagram illustrating a functional structure of a printing system including a print processing apparatus, according to an example embodiment of the present invention;

FIG. 5 is a schematic block diagram illustrating a hardware structure of the print processing apparatus of FIG. 4;

FIG. 6 is a schematic block diagram illustrating a structure of a printer driver user interface and a plugin user interface, each installed on the print processing apparatus of FIG. 4, according to an example embodiment of the present invention;

FIG. 7 is an illustration for explaining information regarding printing parameters stored in the printer driver user interface of FIG. 6;

FIG. 8 is an illustration for explaining a watermark drawing rule, managed by the plugin user interface of FIG. 6;

FIG. 9 is an illustration for explaining a pattern drawing rule, managed by the plugin user interface of FIG. 6;

FIGS. 10A and 10B are a data sequence diagram illustrating operation of drawing an image, performed by the printer driver user interface and the plugin user interface of FIG. 6, according to an example embodiment of the present invention;

FIG. 11 is a flowchart illustrating operation of managing a drawing process, performed by the plugin user interface of FIG. 6, according to an example embodiment of the present invention;

FIG. 12 is an illustration for explaining the order in which a plurality of images is drawn respectively by the printer driver user interface and the plugin user interface of FIG. 6;

FIG. 13 is an illustration for explaining a printer driver user interface displayed by the print processing apparatus of FIG. 4, according to an example embodiment of the present invention;

FIGS. 14A and 14B are a data sequence diagram illustrating operation of drawing an image, performed by the printer driver user interface and the plugin user interface of FIG. 6, according to an example embodiment of the present invention;

FIG. 15 is an illustration for explaining the order in which a plurality of images is drawn respectively by the printer driver user interface and the plugin user interface of FIG. 6; and

FIG. 16 is an illustration for explaining a printer driver user interface displayed by the print processing apparatus of FIG. 4, according to an example embodiment of the present invention.

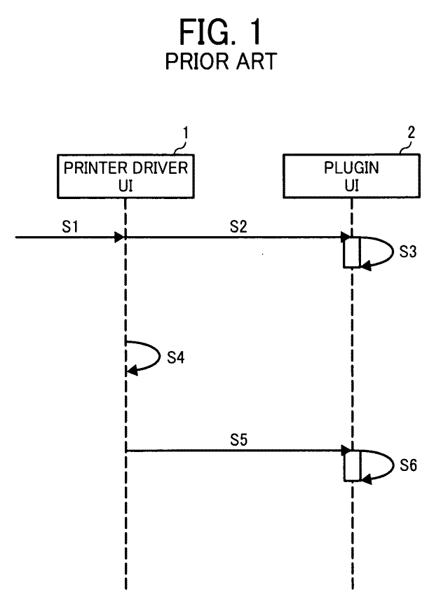

The accompanying drawings are intended to depict example embodiments of the present invention and should not be interpreted to limit the scope thereof. The accompanying drawings are not to be considered as drawn to scale unless explicitly noted.

### DETAILED DESCRIPTION OF EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

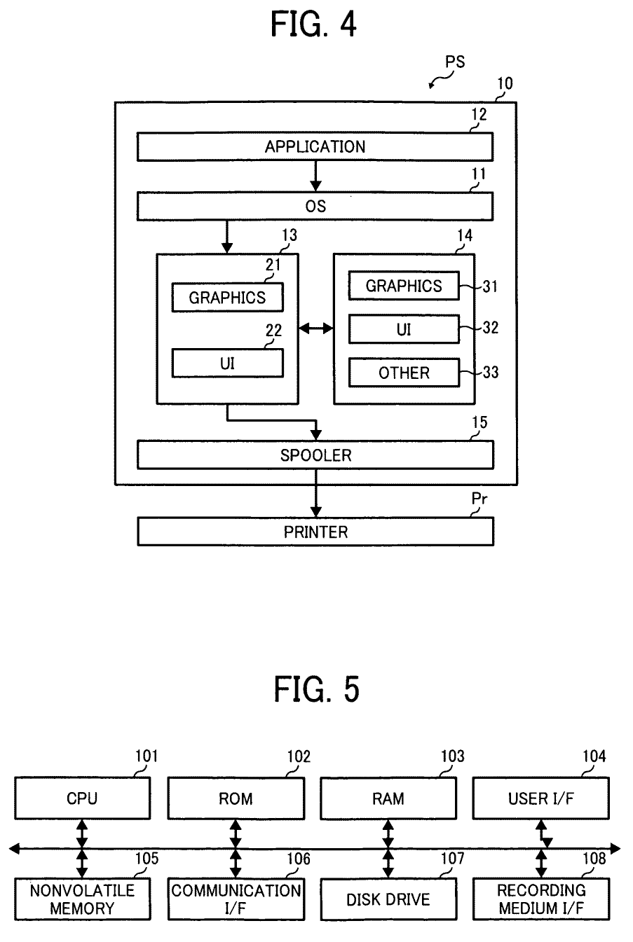

Referring now to FIG. 4, a configuration of a printing system PS is explained according to an example embodiment of the present invention. The printing system PS includes a print processing apparatus such as a computer 10, and an image forming apparatus such as a printer Pr, which are connected through a network such as a local area network (LAN) or a communication line such as a universal serial bus (USB).

In this example, the printing system PS includes one computer 10 and one printer Pr. Alternatively, any number of computers 10 or printers Pr may be provided. Further, the examples of the print processing apparatus or the image forming apparatus are not limited to the computer 10 or the printer Pr.

For example, the print processing apparatus may be implemented by any desired personal device assistance (PDA) including a portable phone or a digital camera, as long as it is capable of generating drawing data to be displayed through a printer driver user interface. The image forming apparatus may be implemented by a multifunctional apparatus (MFP) providing a plurality of image forming functions including, for example, scanning, faxing, copying, and printing.

Alternatively, the print processing apparatus and the image forming apparatus may be incorporated into one apparatus such as a printer, a copier or a multifunctional apparatus, which is capable of receiving print settings information, generating drawing data according to the print settings information, and displaying the drawing data through a printer driver user interface.

Referring now to FIG. 5, an example hardware structure of the computer 10 is explained according to an example embodiment of the present invention. The computer 10 includes a microprocessor such as a central processing unit (CPU) 101, a read only memory (ROM) 102, a random access memory (RAM) 103, a user interface (I/F) 104, a nonvolatile memory 105, a communication interface (I/F) 106, a disk drive 107, and a recording medium interface (I/F) 108, which are connected through a system bus.

The disk drive 107 may be connected to any desired disk device including, for example, a hard disk device (HDD) or a flexible disk. The disk drive 107 writes data to or read data from the disk device under control of the CPU 101.

The recording medium I/F 108 may be connected to a removable recording medium including, for example, a universal serial bus (USB) memory, secure digital (SD) card memory, flash memory, compact disc (CD), compact disc rewritable (CD-RW), digital video disc (DVD), or flexible disk. The recording medium I/F 108 writes data to or read data from the recording medium under control of the CPU 101.

The communication I/F 106 allows the CPU 101 to communicate with other apparatuses such as the printer Pr via the network.

The nonvolatile memory 105 stores various data under control of the CPU 101 in a nonvolatile form such that the data is not automatically deleted after the power of the computer 10 is turned off.

The user I/F 104 allows the user to interact with the computer 10. The user I/F 104 may include an input device such as a mouse or a keyboard, and an output device such as a liquid crystal display (LCD) or a speaker.

The RAM 103 may function as a work area of the CPU 101. The ROM 102 may store various data including, for example, various programs to be run by the CPU 101 or system data.

The CPU 101 controls operation or function of the computer 10, for example, by executing a program being loaded in the RAM 103. The program may be stored in any one of the ROM 102, the nonvolatile memory 105, the disk device connectable to the disk drive 107, the recording medium connectable to the recording medium I/F 108, or any other device accessible from the CPU 101 via the network. The program being stored may include an operating system (OS) 11 (FIG. 4) such as the Windows, an application 12 (FIG. 4), and a printer driver 13 (FIG. 4). Specifically, in this example, the printer driver 13 may be provided with a print processing program that controls operation of generating drawing data to be displayed to a user through a printer driver user interface. The print processing program may be written in any desired language including, for example, the legacy programming language such as assembler, C, C++, C#, Java, or the project-oriented programming language.

Referring back to FIG. 4, a functional structure of the computer 10 is explained according to an example embodiment of the present invention. The computer 10 includes the OS 11, the application 12, the printer driver 13, a plugin 14, and a spooler 15.

In this example, the printer driver 13 is specifically designed for the printer Pr. Further, any number of printer drivers 13 may be provided, each corresponding to a specific printer provided on the printing system PS. The printer driver 13 mainly includes a graphics section 21 and a user interface (UI) section 22.

The UI section 22 generates a printer driver user interface to be displayed to the user, which allows the user to set various print settings information. The UI section 22 further sends the print settings information to the graphics section 21. The graphics section 21 converts drawing data received from the application 12 to print data, which is interpretable by the printer Pr. The print data is generated so as to reflect the print settings information.

The plugin 14 is a software component, which provides a specific function to the printer driver 13. It is assumed that the plugin 14 is installed onto the computer 10 at any desired time after installation of the printer driver 13. The plugin 14 may be previously stored in any desired memory such as in a storage device or in a storage medium. The plugin 14 includes a plugin graphics section 31, a plugin user interface (UI) section 32, and a plugin other function section 33. The graphics plugin section 31 provides a specific graphics function to the graphics section 21 of the printer driver 13. The plugin UI section 32 provides a specific UI function to the UI section 22 of the printer driver 13.

The application 12 may include, for example, a document generating program providing the function of generating or editing document data, a drawing program providing the function of generating drawing data, a spreadsheet program, a database program, etc. In example operation, a user may instruct the application 12 to print data using the printer Pr. The data may be generated using the application 12 or may be received from the outside apparatus through the network. When the application 12 receives a user instruction for printing data, the application 12 sends the instruction for printing to the OS 11. The OS 11 selects the printer driver 13 that corresponds to the printer Pr, and sends a DEVMODE structure including print settings information specific to the printer Pr to the UI section 22 of the printer driver 13.

When the UI section 22 receives the DEVMODE structure, the UI section 22 causes the user I/F 104 of the computer 10 to display a print settings user interface such as a print property dialog. The print settings user interface allows the user to set various print settings including, for example, layout information such as sheet orientation or sheet size. When a user instruction regarding various print settings is received from the user, the printer driver UI section 22 sends a DEVMODE structure including print settings information set by the user through the print property dialog, to the application 12.

The application 12 passes the DEVMODE structure and drawing data to the graphics section 21 of the printer driver 13.

Referring to the DEVMODE structure received from the application 12, the graphics section 21 generates print data from the drawing data. The print data, which is written in printer job language, is generated such that various print settings instructed by the user are reflected. The graphics section 21 sends the print data to the spooler 15.

The spooler 15 stores and manages the print data received from the graphics section 21. The spooler 15 sends the print data through a port monitor to the printer Pr, which is connected to the computer 10 through the network or the communication line.

The printer Pr receives the print data, and prints the print data using any desired image forming method including, for example, ink ejecting method or electrophotographic method.

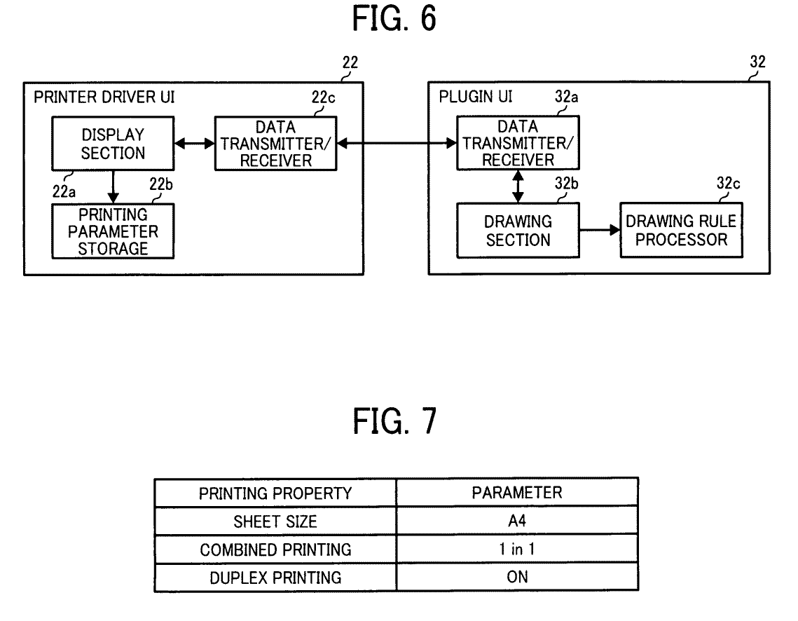

In this example, the UI section 22 of the printer driver 13 (“the printer driver UI section 22”) and the UI section 32 of the plugin 14 (“the plugin UI section 32”) may each be implemented to have a structure illustrated in FIG. 6. Referring to FIG. 6, the printer driver UI section 22 includes a display section 22a, a printing parameter storage 22b, and a data transmitter/receiver 22c. The plugin UI section 32 includes a data transmitter/receiver 32a, a drawing section 32b, and a drawing rule processor 32c. The printer driver UI section 22 and the plugin UI section 32 are communicated with each other through the data transmitter/receiver 22c and the data transmitter/receiver 32a.

The display section 22a of the printer driver UI section 22 causes the display device of the user I/F 140 provided at the computer 10 to display the print settings user interface. Further, the display section 22a generates an image according to information regarding various print settings, which may be stored in the printing parameter storage 22b as a plurality of printing parameters. The image being generated reflects the various print settings, and may be displayed to the user through the print property dialog.

The printing parameter storage 22b stores various parameters to be used for printing (“the printing parameters”). In this example, the printing parameters are organized by printing property type. For example, as illustrated in FIG. 7, the printing parameter storage 22b may store a parameter for the sheet size property which specifies the size of the recording sheet, a parameter for the combined printing property which specifies the number of images to be printed into one page of sheet, and a parameter for the double-sided printing specifying whether to perform double-sided printing. The parameter is updated so as to reflect the current print settings that are set by the user through the print property dialog. As described above, the display section 22a of the printer driver UI section 22 generates a plurality of images, with each image corresponding to one of the printing parameters being stored in the printing parameter storage 22b. Further, in this example, the display section 22a generates the plurality of images in the order specified by the printing parameter storage 22b.

Referring back to FIG. 6, the data transmitter/receiver 22c sends or receives drawing data or message to or from the data transmitter 32a of the plugin UI section 32.

The data transmitter/receiver 32a of the plugin UI section 32 sends or receives a message to or from the data transmitter/receiver 22c of the printer driver UI section 22.

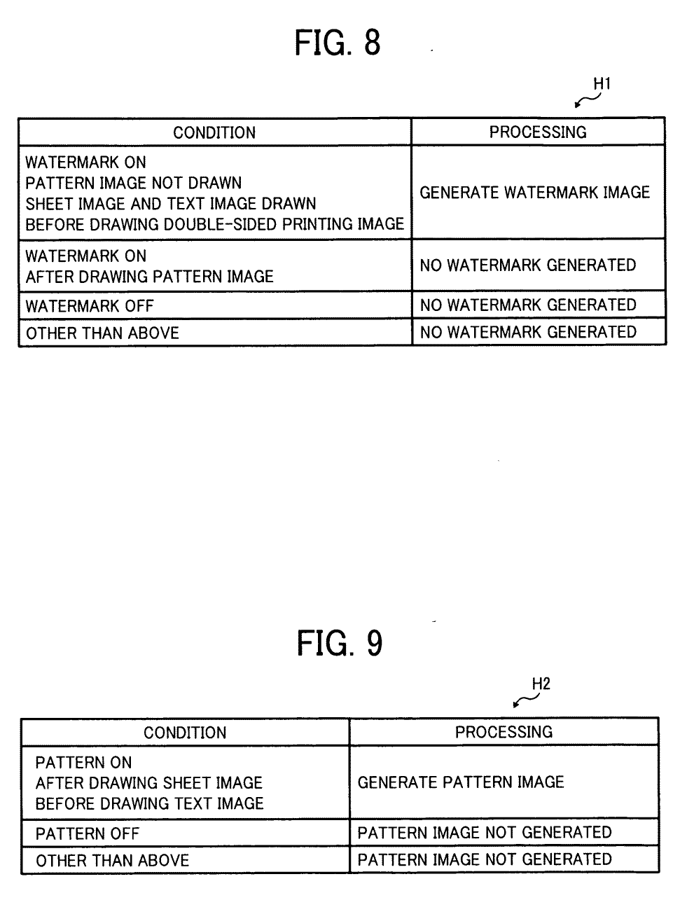

The drawing rule processor 32c stores a drawing rule, which specifies a condition that causes the drawing section 32b to generate an image that corresponds to a specific printing function or printing property provided by the plugin 14. For example, as illustrated in FIG. 8, the drawing rule processor 32c may store a watermark drawing rule H1 in the form of table, which specifies under which condition a watermark image indicating a watermark property is to be generated. In another example, as illustrated in FIG. 9, the drawing rule processor 32c may store a pattern drawing rule H2 in the form of table, which specifies under which condition a pattern is to be generated.

Referring to FIG. 6, the drawing section 32b draws an image according to the drawing rule stored in the drawing rule processor 32c such as the watermark drawing rule H1 or the pattern drawing rule H2. For example, when data such as a message sent from the UI section 22 of the printer driver 13 indicates that the current condition satisfies the condition for generating an image for a specific printing property, which may be obtained from the drawing rule that corresponds to the specific printing property, the drawing section 32b generates an image that corresponds to the specific printing property. The drawing section 32b further generates a message indicating that the image that corresponds to the specific printing property has been generated, and causes the message to be sent to the printer driver UI section 22 through the data transmitter/receiver 32a. When data such as a message sent from the UI section 22 of the printer driver 13 indicates that the current condition does not satisfy the condition for generating an image for a specific printing property, which may be obtained from the drawing rule that corresponds to the specific printing property, the drawing section 32b does not generate an image that corresponds to the specific printing property. In such case, the drawing section 32b generates a message indicating that the image is not generated, and causes the message to be sent to the printer driver UI section 22 through the data transmitter/receiver 32a.

The data transmitter/receiver 32a sends the drawing data such as the image or the message received from the drawing section 32b to the data transmitter/receiver 22c.

The display section 22a of the printer driver UI section 22 combines the drawing data such as the image generated by the display section 22a, and the drawing data such as the image generated by the drawing section 32b of the plugin UI section 32 into a combined image, and causes the display device of the user I/F 140 to display the combined image.

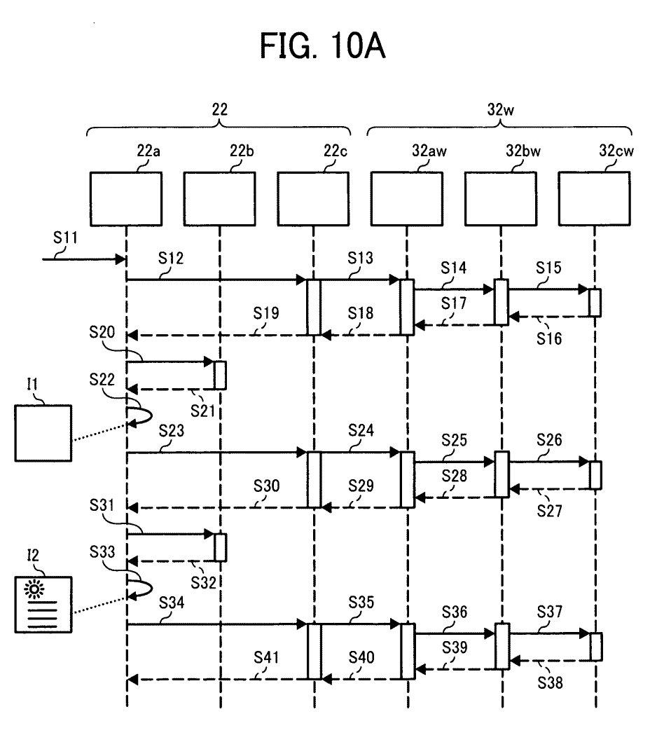

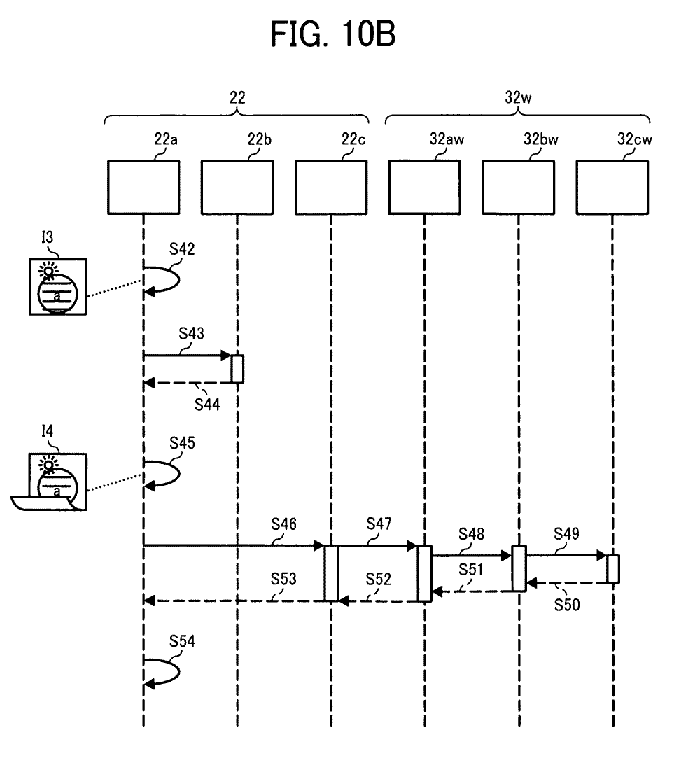

Referring now to FIGS. 10A and 10B, operation of drawing an image, performed by the computer 1, is explained according to an example embodiment of the present invention.

For the illustrative purpose, it is assumed that a watermark plugin 14w providing a function of adding watermark data to data to be printed is additionally installed into the computer 10 as the plugin 14. As illustrated in FIGS. 6, 10A and 10B, the watermark plugin 14w includes a watermark plugin UI section 32w, which includes a data transmitter/receiver 32aw, a drawing section 32bw, and a drawing rule processor 32cw. When the watermark plugin 14w is added, the print settings user interface allows the user to additionally select the watermark property option by additionally displaying a user interface displaying various watermark property options. For example, as illustrated in FIG. 13, the “watermark” tab may be additionally provided to a print property dialog G1 for display to the user. When the watermark option is turned on to indicate that the watermark is to be added through the print settings user interface, the print settings user interface additionally displays a watermark image indicating the addition of the watermark. With this display of the watermark image, the user is able to easily check whether the watermark option has been selected.

As described above referring to FIG. 4, when the OS 11 receives a user instruction for printing data using the printer Pr through the application 12, the OS 11 selects the printer driver 13 that corresponds to the printer Pr, and sends a DEVMODE structure including print settings information to the UI section 22 of the printer driver 13.

Referring to FIG. 10A, at S11, the printer driver UI section 22 receives the DEVMODE structure including print settings information.

At S12, the display section 22a of the printer driver UI section 22 instructs the data transmitter/receiver 22c to send notification indicating that drawing processing is initiated to the data transmitter/receiver 32aw of the watermark plugin UI section 32w.

At S13, the data transmitter/receiver 22c of the printer driver UI section 22 sends the notification to the data transmitter/receiver 32aw of the plugin UI section 32w.

At S14, the data transmitter/receiver 32aw of the plugin UI section 32w sends the notification to the drawing section 32bw of the plugin UI section 32w.

At S15, the drawing section 32bw of the plugin UI section 32w sends the notification to the drawing rule processor 32cw. The drawing rule processor 32cw refers to the watermark drawing rule H1 of FIG. 8 to determine whether to draw a watermark image. Specifically, in this example, the drawing rule processor 32cw analyzes the notification to determine a current condition, which reflects the print settings set by the user and specifies which image has been drawn by the printer driver UI section 22, and obtains processing that corresponds to the determined condition using the watermark drawing rule H1 of FIG. 8.

For example, as illustrated in FIG. 13, it is assumed that, through the print settings user interface such as the print property dialog G1, the user has selected the sheet size option to be “A4”, the combined printing option to be “NO” or “1 in 1”, the duplex printing option to be “ON”, and the watermark option to be “ON”. When the “OK” button is pressed, the printer driver UI section 22 receives the print settings information, and stores the print settings information, or the printing parameters that are set, in the printing parameter storage 22b as described above referring to FIG. 7. Further, the print settings information may be sent to the drawing rule processor 32cw of the watermark plugin UI section 32w in the form of notification, together with information that the drawing process is initiated. From the notification, the drawing rule processor 32cw of the watermark plugin UI section 32w obtains information regarding the current print settings and information regarding the current processing status. In this example, the current processing status indicates how far the operation of drawing a plurality of images each corresponding to a plurality of printing parameters obtainable from the current print settings is completed.

More specifically, the rule processor 32cw determines whether the current condition, which may be specified by the current print settings and the current processing status, satisfy any one of the conditions of the watermark drawing rule H1. For example, the rule processor 32cw may determine whether the current print settings and the current processing status satisfy the condition that indicates generation of the watermark image. In this example, the current print settings and the current processing status satisfy one condition that the watermark option is selected and one condition that the pattern image is not drawn. However, the current print settings and the current processing status do not satisfy the condition indicating that a sheet image and a text image are drawn. As a result, the rule processor 32cw determines that the current print settings and the current processing status satisfy the condition “OTHER THAN ABOVE”, and determines that no watermark image is to be generated at this time.

Referring to FIG. 10A, at S16, the drawing rule processor 32cw sends a response to the drawing section 32bw. In the response, information regarding an operation result such as the processing that corresponds to the current print settings and the current processing status is included. More specifically, in this example, the drawing rule processor 32cw sends the response indicating that no drawing is performed.

At S17, the drawing section 32bw of the watermark plugin UI section 32w sends the response to the data transmitter/receiver 32aw.

At S18, the data transmitter/receiver 32aw sends the response to the data transmitter/receiver 22c of the printer driver UI section 22.

At S19, the data transmitter/receiver 22 sends the response to the display section 22a of the printer driver UI section 22.

At S20, the display section 22a requests the printing parameter storage 22b to send a printing parameter that is stored in the printing parameter storage 22b, which is previously set as the printing parameter to be firstly processed.

At S21, the printing parameter storage 22b reads out the printing parameter that is previously set as the printing parameter to be firstly processed. In this example, the printing parameter storage 22b obtains a parameter that corresponds to the sheet size property, and sends the obtained parameter to the display section 22a. In this example, it is assumed that the sheet size of A4 has been selected.

At S22, the display section 22a draws a sheet image I1 that corresponds to the sheet size property having the A4 sheet size, for example, as illustrated in FIG. 10A.

At S23, the display section 22a requests the data transmitter/receiver 22c to send notification indicating that the sheet image I1 is drawn to the watermark plugin UI section 32w.

At S24, the data transmitter/receiver 22c sends the notification to the data transmitter/receiver 32aw of the watermark plugin UI section 32w.

At S25, the data transmitter/receiver 32aw sends the notification to the drawing section 32bw.

At S26, the drawing section 32bw passes the notification to the drawing rule processor 32cw to determine whether to draw a watermark image. The drawing rule processor 32cw refers to the watermark drawing rule H1 to select one of the conditions that satisfies the current print settings and the current processing status in a substantially similar manner as described above referring to S15. In this example, the drawing rule processor 32cw determines that the current print settings and current processing status satisfy the condition “OTHER THAN ABOVE”, and determines not to generate the watermark image.

At S27, in response to the notification, the drawing rule processor 32cw sends a response indicating that no watermark image is generated to the drawing section 32bw.

At S28, the drawing section 32bw sends the response to the data transmitter/receiver 32aw.

At S29, the data transmitter/receiver 32aw sends the response to the data transmitter/receiver 22c of the printer driver UI section 22.

At S30, the data transmitter/receiver 22c sends the response to the display section 22a of the printer driver UI section 22.

At S31, the display section 22a requests the printing parameter storage 22b to send a printing parameter that is stored in the printing parameter storage 22b, which is previously set as the printing parameter to be processed next.

At S32, the printing parameter storage 22b reads out the printing parameter for the printing property, which is previously set to be read after the sheet size property is read. In this example, the printing parameter storage 22b obtains a parameter that corresponds to the combined printing property, and sends the obtained parameter to the display section 22a. In this example, it is assumed that no combining or “1 in 1” option has been selected.

At S33, the display section 22a draws a text image that corresponds to the combined printing property having the “1 in 1” option, for example, as illustrated in FIG. 10A. As illustrated in FIG. 10A, the text image is added to the sheet image I1 to generate a combined image I2 having the sheet image I1 and the text image.

At S34, the display section 22a requests the data transmitter/receiver 22c to send notification indicating that the text image I2 is drawn to the watermark plugin UI section 32w.

At S35, the data transmitter/receiver 22c sends the notification to the data transmitter/receiver 32aw of the watermark plugin UI section 32w.

At S36, the data transmitter/receiver 32aw sends the notification to the drawing section 32bw.

At S37, the drawing section 32bw passes the notification to the drawing rule processor 32cw to determine whether to draw a watermark image. The drawing rule processor 32cw refers to the watermark drawing rule H1 to determine one of the conditions that satisfies the current print settings and the current processing status in a substantially similar manner as described above referring to S15. In this example, the drawing rule processor 32cw determines that the current printing settings and current processing status satisfy the condition of generating the watermark image, and determines to generate the watermark image.

At S38, in response to the notification, the drawing rule processor 32cw sends a response indicating that the watermark image is to be generated to the drawing section 32bw. The drawing section 32bw generates the watermark image.

At S39, the drawing section 32bw sends the response to the data transmitter/receiver 32aw. In this example, the response includes information that the watermark image is drawn and the watermark image.

At S40, the data transmitter/receiver 32aw sends the response to the data transmitter/receiver 22c of the printer driver UI section 22.

At S41, the data transmitter/receiver 22c sends the response to the display section 22a of the printer driver UI section 22. In this example, the response includes information regarding the current processing status indicating that the watermark is drawn, and the watermark image.

Referring to FIG. 10B, at S42, the display section 22a receives the watermark image, and adds the watermark image to the combined image I2 to generate a combined image I3 having the sheet image, the text image, and the watermark image.

At S43, the display section 22a further requests the printing parameter storage 22b to send a printing parameter that is stored in the printing parameter storage 22b, which is previously set as the printing parameter to be processed next.

At S44, the printing parameter storage 22b reads out the printing parameter indicating the printing property, which is previously set to be read next. In this example, the printing parameter storage 22b obtains a parameter that corresponds to the duplex printing property, and sends the obtained parameter to the display section 22a. In this example, it is assumed that the duplex printing has been selected.

At S45, the display section 22a draws a duplex printing image that corresponds to the duplex printing property indicating the selection of duplex printing, for example, as illustrated in FIG. 10B. As illustrated in FIG. 10B, the duplex printing image is added to the combined image I3 to generate a combined image I4 having the sheet image, the text image, the watermark image, and the duplex printing image.

At S46, the display section 22a requests the data transmitter/receiver 22c to send notification indicating that addition of the watermark image and the duplex printing image to the watermark plugin UI section 32w.

At S47, the data transmitter/receiver 22c sends the notification to the data transmitter/receiver 32aw of the watermark plugin UI section 32w.

At S48, the data transmitter/receiver 32aw sends the notification to the drawing section 32bw.

At S49, the drawing section 32bw passes the notification to the drawing rule processor 32cw to determine whether to draw a watermark image. The drawing rule processor 32cw refers to the watermark drawing rule H1 to determine one of the conditions that satisfies the current print settings and the current processing status in a substantially similar manner as described above referring to S15. In this example, the drawing rule processor 32cw determines that the current printing settings and current processing status satisfy the condition “OTHER THAN ABOVE”, and determines not to generate the watermark image.

At S50, in response to the notification, the drawing rule processor 32cw sends a response indicating that no watermark image is generated to the drawing section 32bw.

At S51, the drawing section 32bw sends the response to the data transmitter/receiver 32aw.

At S52, the data transmitter/receiver 32aw sends the response to the data transmitter/receiver 22c of the printer driver UI section 22.

At S53, the data transmitter/receiver 22c sends the response to the display section 22a of the printer driver UI section 22.

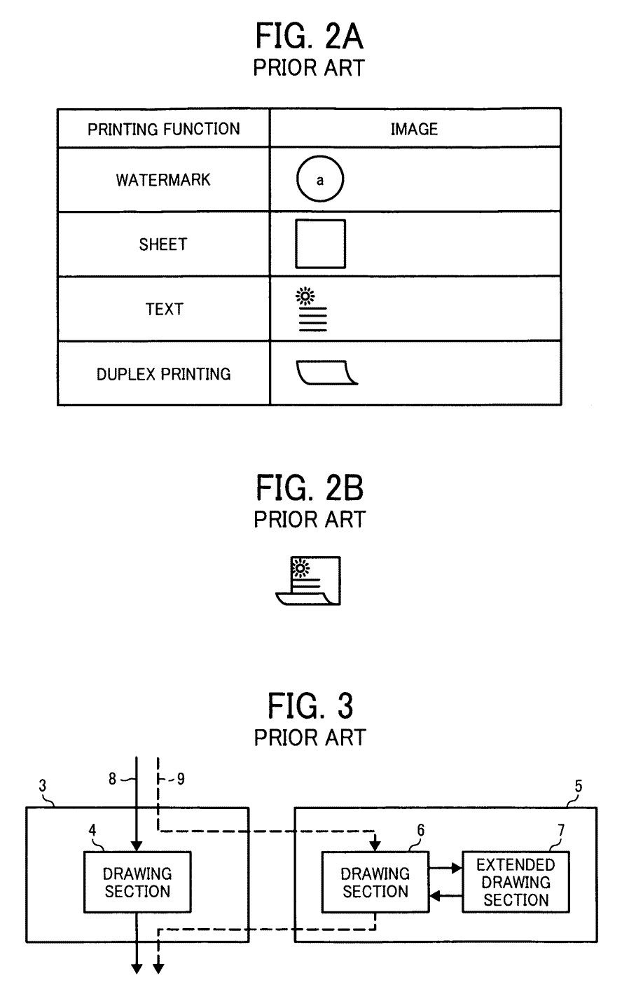

At S54, the display section 22a determines whether further processing is needed. When no further processing is needed, the display section 22a causes the combined image I4 to be displayed through the user I/F 104, and the operation ends. For example, as illustrated in FIG. 13, the printer driver UI section 22 causes the printer property dialog G1 to display the combined image I4 in a display section A. Compared to the image of FIG. 2B, which is drawn using the background technique, the watermark image that corresponds to the watermark function is clearly displayed even though more than one image has been combined.

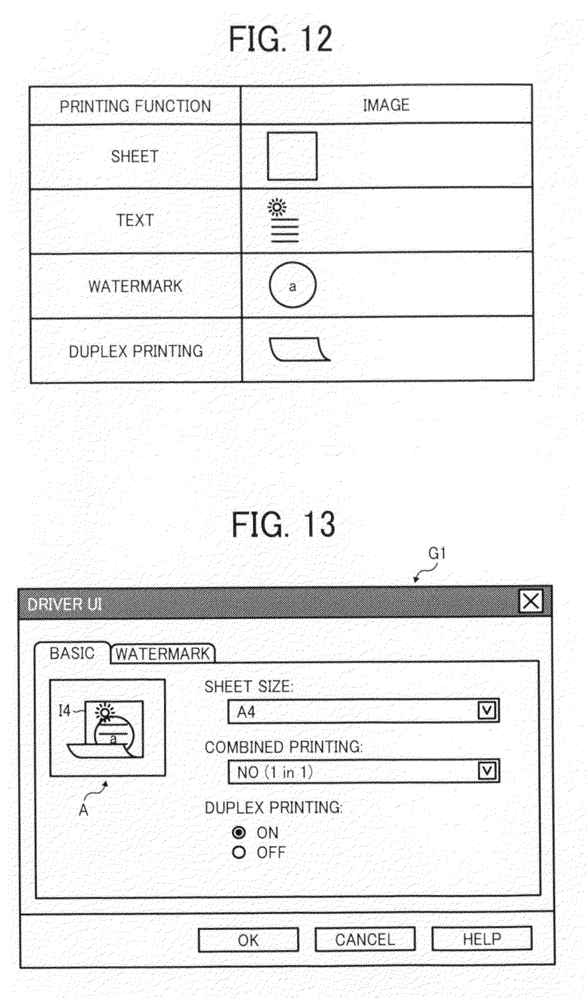

More specifically, in this example, the watermark plugin 14w is provided with the watermark drawing rule H1, which specifies the condition for generating a watermark image. As illustrated in FIG. 12, the watermark drawing rule H1 may be previously set such that the watermark image is drawn after the sheet image and the text image are drawn, but before the duplex printing is drawn. With this watermark drawing rule H1, the watermark plugin 14w knows when to draw the watermark image as long as information regarding the current print settings and the current processing status is received. The watermark drawing rule H1 of FIG. 8 may be adjustable, for example, according to the specific functions that are provided by the printer driver 13.

Further, in this example, the printer driver 13 is provided with the printer driver UI section 22, which is capable of sending or receiving information regarding the current print settings and the current processing status to or from the plugin UI section 32. With this communication function, the printer driver 13 knows when to draw a plurality of images that corresponds to its own function or when to add the watermark image provided by the watermark plugin 14w as long as information regarding the current print settings and the current processing status is received. In such case, the printer driver 13 does not have to change the settings stored in the printing parameter storage 22b, such as the settings regarding the order of generating the images. This allows the printer driver 13 to be applicable to any type of plugin, or any number of plugin, thus improving the scalability of the printing system PS.

The operation of FIGS. 10A and 10B may be performed in various other ways. For example, the notification being communicated between the printer driver UI section 22 and the plugin UI section 32 may not always include information regarding the current print settings, unless there is another user input that causes the current print settings information to change.

Further, in this example, the current processing status information, which is included in the notification being communicated between the printer driver UI section 22 and the plugin UI section 32, may include a log of the images being generated or a log of the plurality of printing parameters being applied. Alternatively, the current processing status information may only include additional information to be used for updating the processing status information.

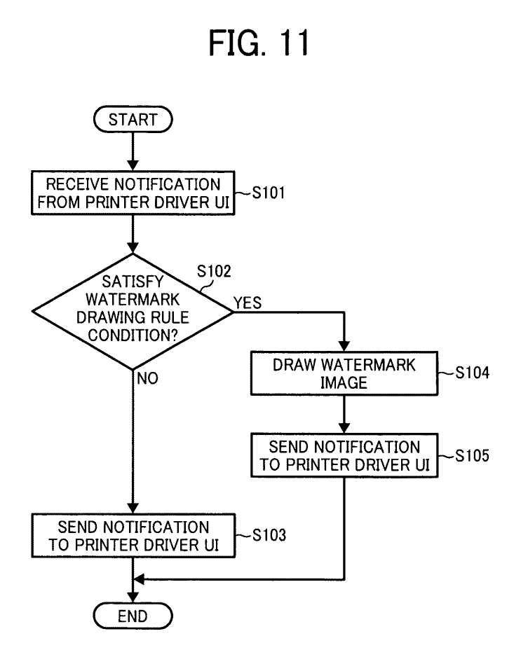

Referring to FIG. 11, operation of controlling drawing process, performed by the watermark plugin UI section 32w, is explained according to an example embodiment of the present invention.

At S100, the watermark plugin UI section 32w receives notification from the printer driver UI section 22. The notification includes information regarding the current print settings and the current processing status.

At S102, the watermark plugin UI section 32w determines whether the current print settings and the current processing status satisfy the watermark drawing condition indicating that the watermark is to be drawn, for example, by referring to the watermark drawing rule H1. When it is determined that the current print settings and the current processing status satisfy the watermark drawing condition (“YES” at S102), the operation proceeds to S104. When it is determined that the current print settings and the current processing types do not satisfy the watermark drawing condition (“NO” at S102), the operation proceeds to S103.

At S103, the watermark plugin UI section 32w sends notification indicating that no watermark image is drawn, to the printer driver UI section 22, and the operation ends.

When it is determined that the current print settings and the current processing status satisfy the watermark drawing condition (“YES” at S102), the operation proceeds to S104 to cause the display section 32bw to draw the watermark image.

At S105, the watermark plugin UI section 32w sends notification indicating that the watermark image is generated, together with the watermark image, to the printer driver UI section 22, and the operation ends.

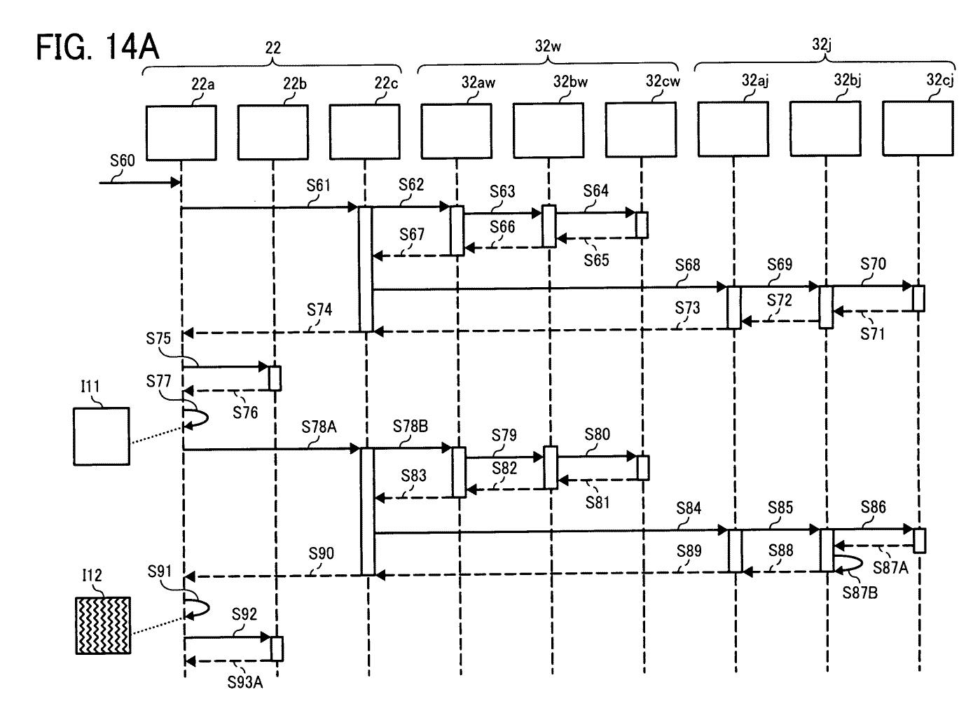

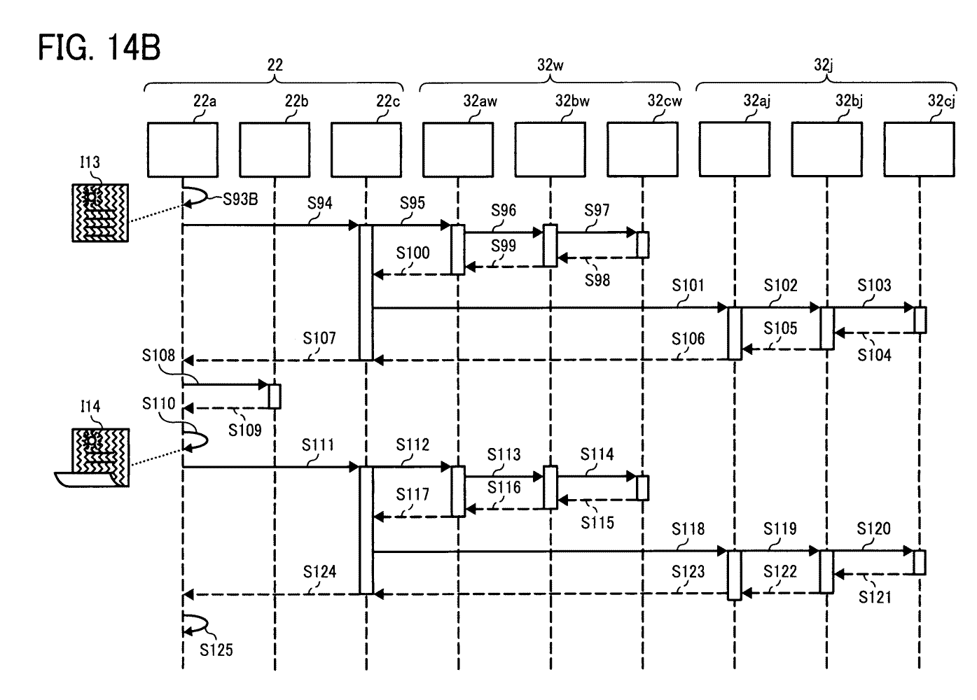

Referring now to FIGS. 14A and 14B, operation of drawing an image, performed by the computer 1, is explained according to an example embodiment of the present invention.

For the illustrative purpose, it is assumed a pattern plugin 14j providing a function of adding pattern data to data to be printed is additionally installed as the plugin 14, after installation of the watermark plugin 14w. As illustrated in FIGS. 6, 14A and 14B, the pattern plugin 14j includes a pattern plugin UI section 32j, which includes a data transmitter/receiver 32aj, a drawing section 32bj, and a drawing rule processor 32cj. When the watermark plugin 14w and the pattern plugin 14j are added, the print setting user interface allows the user to additionally select the watermark property option and the pattern property option by additionally displaying a user interface displaying various watermark property options and a user interface displaying various pattern property options. For example, as illustrated in FIG. 16, the “watermark” tab and the “pattern” tab may be additionally provided to a printer property dialog G2 for display to the user. When the watermark option is turned on to indicate that the watermark is to be added through the print settings user interface, the print settings user interface additionally displays a watermark image indicating the addition of the watermark. Further, when the pattern option is turned on to indicate that the pattern is to be added through the print settings user interface, the print settings user interface additionally displays a pattern image indicating the addition of the pattern. With this display of the watermark image and/or the pattern image, the user is able to easily check whether the watermark option and/or the pattern option has been selected.

As described above referring to FIG. 4, when the OS 11 receives a user instruction for printing data using the printer Pr through the application 12, the OS 11 selects the printer driver 13 that corresponds to the printer Pr, and sends a DEVMODE structure including print settings information to the UI section 22 of the printer driver 13. Referring to FIG. 14A, S60 to S67 are performed in a substantially similar manner as described above referring to S11 to S18 of FIG. 10A.

In this example, as illustrated in FIG. 16, it is assumed that, through the print settings user interface such as the print property dialog G2, the user has selected the sheet size option to be “A4”, the combined printing option to be “NO” or “1 in 1”, the duplex printing option to be “ON”, the watermark option to be “OFF”, and the pattern option to be “ON”. When the DEVMODE structure including information regarding the current print settings is received at S60, at S61 and S62, the display section 22a of the printer driver UI section 22 sends notification including the current print settings and the current processing status to the data transmitter/receiver 32aw of the watermark plugin UI section 32 through the data transmitter/receiver 22c. At S63 and S64, the data transmitter/receiver 32aw sends the notification to the drawing rule processor 32cw through the drawing section 32bw.

At S64, the rule processor 32cw of the watermark plugin 14w determines whether the current print settings and the current processing status, which are obtainable from the notification, satisfy any one of the conditions of the watermark drawing rule H1 of FIG. 8. In this example, the rule processor 32cw determines that the current print settings and the current processing status satisfy the condition “OTHER THAN ABOVE”, and determines that no watermark image is to be generated. At S65, S66, and S67, the drawing rule processor 32cw sends the response indicating that no watermark image is drawn to the drawing section 32bw through the drawing section 32bw and the data transmitter/receiver 32aw to the data transmitter/receiver 22c of the printer driver UI section 22.

Referring to FIG. 14A, when the response indicating that no watermark is drawn is received from the watermark plugin UI section 32w, at S68, the data transmitter/receiver 22c of the printer driver UI section 22 sends notification requesting initiation of the drawing process to the data transmitter/receiver 32aj of the pattern plugin UI section 32j. The notification includes information regarding the current print settings and the current processing status.

At S69, the data transmitter/receiver 32aj sends the notification to the drawing section 32bj.

At S70, the drawing section 32bj sends the notification to the drawing rule processor 32cj. The drawing rule processor 32cj refers to the pattern drawing rule H2 of FIG. 9 to determine whether to draw a pattern image. Specifically, in this example, the drawing rule processor 32cj analyzes the notification to determine a current condition, which reflects the print settings set by the user and specifies which image has been drawn by the printer driver UI section 22 or the watermark plugin UI section 32w, and obtains processing that corresponds to the determined condition using the pattern drawing rule H2 of FIG. 9.

More specifically, in this example, the rule processor 32cj determines whether the current print settings and the current processing status satisfy any one of the conditions of the pattern drawing rule H2. In this example, the current print settings and the current processing status satisfy one condition that the pattern option is selected. However, the current print settings and the current processing status do not satisfy the condition indicating that a sheet image is drawn. As a result, the rule processor 32cj determines that the current print settings and the current processing status satisfy the condition “OTHER THAN ABOVE”, and determines that no pattern image is to be generated at this time.

Referring to FIG. 14A, at S71, the drawing rule processor 32cj sends a response indicating that no drawing is performed to the drawing section 32bj.

At S72, the drawing section 32bj of the pattern plugin UI section 32j sends the response to the data transmitter/receiver 32aj.

At S73, the data transmitter/receiver 32aj sends the response to the data transmitter/receiver 22c of the printer driver UI section 22.

At S74, the data transmitter/receiver 22c sends the response to the display section 22a of the printer driver UI section 22, in a substantially similar manner as described above referring to S19 of FIG. 10A. The response includes information regarding the current processing status, which indicates that no watermark image is drawn and no pattern image is drawn.

S75 to S83 are performed in a substantially similar manner as described above referring to S20 to S29 of FIG. 10A.

More specifically, as illustrated in FIG. 14A, at S77, the display section 22a of the printer driver UI section 22 draws a sheet image I11, which is previously set to be firstly drawn. At S78A, the display section 22a further requests the data transmitter/receiver 22c to send notification to the watermark plugin UI section 32w and the pattern plugin UI section 32j. The notification includes information regarding the updated current processing status, which indicates that the text image has been drawn.

When the notification is received, at S80, the watermark plugin UI section 32w determines whether to draw the watermark image based on the current print settings and the current processing status by referring to the watermark drawing rule H1 of FIG. 8. In this example, the watermark plugin UI section 32w determines that no watermark image is drawn, and sends the response indicating that no watermark image is drawn to the printer driver UI section 22.

At S84, the data transmitter/receiver 22c of the printer driver UI section 22 sends notification including information regarding the current processing status to the data transmitter/receiver 32aj of the pattern plugin UI section 32j. The current processing status indicates that the sheet image I11 is drawn and no watermark image is drawn.

At S85, the data transmitter/receiver 32aj sends the notification to the drawing section 32bj.

At S86, the drawing section 32bj passes the notification to the drawing rule processor 32cj to determine whether to draw a pattern image. The drawing rule processor 32cj refers to the pattern drawing rule H2 to select one of the conditions that satisfies the current print settings and the current processing status in a substantially similar manner as described above referring to S70. In this example, the drawing rule processor 32cj determines that the current print settings and current processing status satisfy the condition of generating the pattern image, and determines to generate the pattern image.

At S87A, in response to the notification, the drawing rule processor 32cj sends a response indicating that the pattern image is to be generated to the drawing section 32bj.

At S87B, the drawing section 32bj generates the pattern image.

At S88, the drawing section 32bj sends the response to the data transmitter/receiver 32aj. In this example, the response includes information that the pattern image is drawn, and the pattern image.

At S89, the data transmitter/receiver 32aj sends the response to the data transmitter/receiver 22c of the printer driver UI section 22.

At S90, the data transmitter/receiver 22c sends the response to the display section 22a of the printer driver UI section 22. In this example, the response includes information regarding the current processing status, which indicates that the watermark image is not drawn and the pattern image is drawn. Further, the pattern image is sent together with the notification.

Referring to FIG. 14A, at S91, the display section 22a receives the pattern image, and adds the pattern image to the sheet image I11 to generate a combined image I12 having the sheet image and the pattern image.

S92 to S100 are performed in a substantially similar manner as described above referring to S31 to S40 of FIG. 10A. More specifically, at S93B, the display section 22a of the printer driver UI section 22 draws the text image, combines the text image with the combined image I12 to generate a combined image I13 having the sheet image, pattern image, and the text image. The display section 22a further requests the data transmitter/receiver 22c to send notification to the watermark plugin UI section 32w and the pattern plugin UI section 32j. The notification includes information regarding the current processing status, which indicates that the text image is drawn, the pattern image is drawn, and the text image is drawn. When the notification is received through the data transmitter/receiver 32aw, the watermark plugin UI section 32w determines whether to draw a watermark image by referring to the watermark drawing rule H1. In this example, at S97, the watermark plugin UI section 32w determines that no watermark image is to be generated, and sends notification that no watermark is generated to the printer driver UI section 22.

At S101, the data transmitter/receiver 22c sends the notification to the data transmitter/receiver 32aj of the pattern plugin UI section 32j.

At S102, the data transmitter/receiver 32aj sends the notification to the drawing section 32bj.

At S103, the drawing section 32bj passes the notification to the drawing rule processor 32cj to determine whether to draw a pattern image. The drawing rule processor 32cj refers to the pattern drawing rule H2 to determine one of the conditions that satisfies the current print settings and the current processing status in a substantially similar manner as described above referring to S70 or S86. In this example, the drawing rule processor 32cj determines that the current printing settings and current processing status satisfy the condition “OTHER THAN ABOVE”, and determines that no pattern image is to be drawn.

At S104, in response to the notification, the drawing rule processor 32cj sends a response indicating that not pattern image is to be generated to the drawing section 32bj.

At S105, the drawing section 32bj sends the response to the data transmitter/receiver 32aj. In this example, the response includes information that no pattern image is drawn.

At S106, the data transmitter/receiver 32aj sends the response to the data transmitter/receiver 22c of the printer driver UI section 22.

At S107, the data transmitter/receiver 22 sends the response to the display section 22a of the printer driver UI section 22. The response includes information regarding the current processing status.

S108 to S117 are performed in a substantially similar manner as described above referring to S43 to S53 of FIG. 10B. More specifically, the display section 22a draws a duplex-printing image, and adds the duplex-printing image to the combined image I13 to generate a combined image I14 having the sheet image, the pattern image, the text image, and the duplex-printing image. The display section 22a further requests the data transmitter/receiver 22c to send notification to the watermark plugin UI section 32w and the pattern plugin UI section 32j. The notification includes information regarding the current processing status, which indicates that the sheet image is drawn, the pattern image is drawn, the text image is drawn, and the duplex-printing image is drawn.

At S118, the data transmitter/receiver 22c sends the notification to the data transmitter/receiver 32aj of the pattern plugin UI section 32j.

At S119, the data transmitter/receiver 32aw sends the notification to the drawing section 32bj.

At S120, the drawing section 32bj passes the notification to the drawing rule processor 32cj to determine whether to draw the pattern image. The drawing rule processor 32cj refers to the pattern drawing rule H2 to determine one of the conditions that satisfies the current print settings and the current processing status in a substantially similar manner as described above referring to S70, S86, or S103. In this example, the drawing rule processor 32cj determines that the current printing settings and current processing status satisfy the condition “OTHER THAN ABOVE”, and determines not to generate the pattern image.

At S121, in response to the notification, the drawing rule processor 32cj sends a response indicating that no image is generated to the drawing section 32bj.

At S122, the drawing section 32bj sends the response to the data transmitter/receiver 32aj.

At S123, the data transmitter/receiver 32aj sends the response to the data transmitter/receiver 22c of the printer driver UI section 22.

At S124, the data transmitter/receiver 22c sends the response to the display section 22a of the printer driver UI section 22.

At S125, the display section 22a determines whether further processing is needed. When no further processing is needed, the display section 22a causes the combined image I14 to be displayed through the user I/F 104, and the operation ends. For example, as illustrated in FIG. 16, the printer driver UI section 22 causes the printer property dialog G2 to display the combined image I14 in a display section A. The pattern image that corresponds to the pattern function is clearly displayed even though more than one image has been combined.

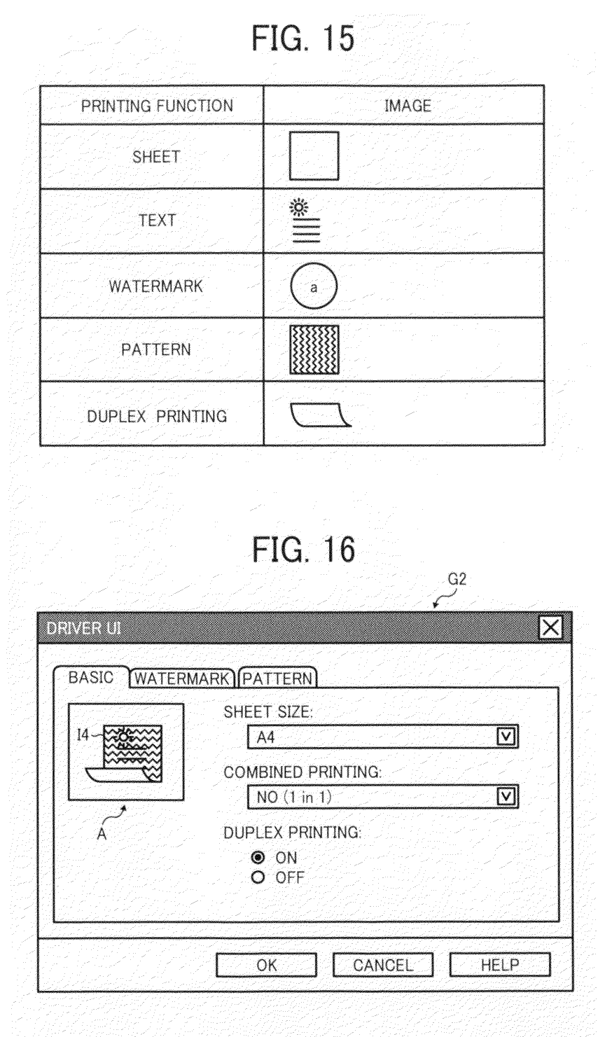

More specifically, in this example, the pattern plugin 14j is provided with the pattern drawing rule H2, which specifies the condition for generating a pattern image. As illustrated in FIG. 15, the pattern drawing rule H2 may be previously set such that the pattern image is drawn after the sheet image, the text image, and the watermark image are drawn, but before the duplex printing is drawn. With this pattern drawing rule H2, the pattern plugin 14j knows when to draw the pattern image as long as information regarding the current print settings and the current processing status is received. The pattern drawing rule H2 of FIG. 9 may be adjustable, for example, according to the specific functions that are provided by the printer driver 13 and/or the specific functions that are provided by the plugin 14 that is previously installed before installation of the pattern plugin 14j.

Further, in this example, the printer driver 13 is provided with the printer driver UI section 22, which sends or receives information regarding the current print settings and the current processing status to or from a plurality of plugin UI sections 32, in the order determined by the order in which the plurality of plugin components 14 are installed. More specifically, in this example, as the watermark plugin 14w is installed first and the pattern plugin 14j is installed second, the printer driver 13 communicates in the order starting from the watermark plugin 14w. Further, when information regarding the current processing status is updated by the watermark plugin 14w, such information is sent to the pattern plugin 14j. With this communication function, even when more than one plugin is added, the printer driver 13 knows when to draw a plurality of images that corresponds to its own function or when to add the watermark image provided by the plugin 14 as long as information regarding the current print settings and the current processing status is received. In such case, the printer driver 13 does not have to change the settings stored in printing parameter storage 22b, such as the settings regarding the order of generating the images. Further, the previously installed plugin 14 does not have to change the settings stored in the drawing rule processor 32c. This allows the printer driver 13 or the plugin 14 to be applicable to any type of plugin, or any number of plugin, thus improving the scalability of the printing system PS.

The operation of FIGS. 14A and 14B may be performed in various other ways, in a substantially similar manner as described above referring to FIGS. 10A and 10B.

Numerous additional modifications and variations are possible in light of the above teachings. It is therefore to be understood that within the scope of the appended claims, the disclosure of the present invention may be practiced otherwise than as specifically described herein.

With some embodiments of the present invention having thus been described, it will be obvious that the same may be varied in many ways. Such variations are not to be regarded as a departure from the spirit and scope of the present invention, and all such modifications are intended to be included within the scope of the present invention.

For example, elements and/or features of different illustrative embodiments may be combined with each other and/or substituted for each other within the scope of this disclosure and appended claims.

In one example, the type or number of plugin components 14 to be installed onto the computer 10 is not limited to the above-described example. Any desired type or number of plugin components 14 may be installed.

Further, as described above, any one of the above-described and other methods of the present invention may be embodied in the form of a computer program stored in any kind of storage medium. Examples of storage mediums include, but are not limited to, flexible disk, hard disk, optical discs such as compact disc read only memory (CD-ROM), compact disc rewritable (CD-RW), or DVD, magneto-optical discs, magnetic tapes, nonvolatile memory cards such as secure digital (SD) card, ROM (read-only-memory), electrically erasable and programmable ROM (EEPROM), EPROM, flash memory, etc. Any component of the print processing program of the present invention may be distributed through the recording medium or through the network, for example, as software package.

Alternatively, any one of the above-described and other methods of the present invention may be implemented by ASIC, prepared by interconnecting an appropriate network of conventional component circuits or by a combination thereof with one or more conventional general purpose microprocessors and/or signal processors programmed accordingly.

In one example, the present invention may reside in a print processing apparatus, which includes a primary user interface and an additional user interface. The primary user interface generates a plurality of images, each image corresponding to one of a plurality of printing parameters obtainable from print settings information. The plurality of images is generated in an order previously set. The additional user interface generates an added image when one of the plurality of printing parameters corresponds to the added image, and provides the added image to the primary user interface. The primary user interface may combine the plurality of images being generated by the primary user interface with the added image provided by the additional user interface to generate a combined image. The combined image may be output, for example, through a printer driver user interface, as an image reflecting the print settings information.

In the above-described example, the primary user interface includes a printing parameter storage to store the plurality of printing parameters, a drawing section to generate the plurality of images each corresponding to one of the plurality of printing parameters, and a notifying section to send notification including current print settings information and current processing status information to the added user interface device. For example, when the drawing section generates the image corresponding to one of the plurality of printing parameters, the notifying section sends notification indicating generation of the image, or for which one of the plurality of printing parameters the image is generated.

In the above-described example, the added user interface device includes a drawing rule processor, a drawing section, and a notifying section. The drawing rule processor may be provided with drawing rule information specifying a condition of which the added image is to be generated by the added user interface device. When a condition specified by the processing status information received from the primary user interface satisfies the condition set by the drawing rule information, the drawing section generates the added image. In such case, the notifying section sends notification including information indicating generation of the added image. Further, the added image is sent to the primary user interface device. The primary user interface device generates the combined image by adding the added image.

When the condition specified by the processing status information does not satisfy the condition set by the drawing rule information, the drawing section does not generate the added image, and causes the notifying section to send notification including information indicating that the added image is not generated.

What is claimed is:

1. A print processing apparatus, comprising:
an input device configured to receive a user input including print settings information;
a primary user interface device configured to obtain a plurality of printing parameters from the print settings information and to generate an image to be output using the plurality of printing parameters; and
an added user interface device being installed after installation of the primary user interface device and to provide an added image to the primary user interface device when the added image corresponds to one of the plurality of printing parameters, wherein:
the primary user interface device includes:
a notifying section configured to send notification to the added user interface device, the notification including current processing status information indicating whether an image corresponding to any one of the plurality of printing parameters is generated, and
the added user interface device includes:
a drawing rule processor configured to obtain drawing rule information specially created for the added user interface device, the drawing rule information specifying a condition of which the added image is to be generated by the added user interface device, to determine whether a current condition specified at least by the current processing status information obtained from the notification being sent from the primary user interface device satisfies the condition of which the added image is to be generated to generate a determination result, and to generate the added image when the determination result indicates that the current condition satisfies the condition of which the added image is to be generated; and
a notifying section configured to send notification to the primary user interface device in response to the notification being received from the primary user interface device, the notification including current processing status information indicating whether the added image is generated.

2. The print processing apparatus of claim 1, wherein, when the added user interface device includes a plurality of added user interface devices, the notifying section of the primary user interface device is further configured to:
determine an order of communicating the plurality of added user interface devices based on the order of which the plurality of added user interface devices are installed; and
send the notification respectively to the plurality of added user interface devices in the determined order of communicating.

3. The print processing apparatus of claim 2, wherein, when the plurality of added user interface devices includes a first added user interface and a second added user interface, the notifying section of the primary user interface device is further configured to:
receive, from the first added user interface, the notification including current processing status information indicating whether the added image is generated by the first added user interface; and
send, to the second added user interface device, the notification including current processing status information being updated using the current processing status information indicating whether the added image is generated by the first added user interface.

4. The print processing apparatus of claim 1, wherein, when the added image is generated,
the added user interface device is further configured to send the added image in addition to the notification to the primary user interface device, and
the primary user interface device is further configured to combine an image generated by the primary user interface and the added image into a combined image, and to cause an output device to output the combined image as the image to be output when the primary user interface device determines that the combined image reflects all of the plurality of printing parameters.

5. A method of generating an image to be used for print processing, the method comprising:
installing a primary user interface device onto a print processing apparatus;
installing an added user interface device onto the print processing apparatus after installation of the primary user interface device;
receiving, through an input device, a user input including print settings information;
obtaining, by the primary user interface device, a plurality of printing parameters from the print settings information;
sending notification from the primary user interface device to the added user interface device, the notification including current processing status information indicating whether an image corresponding to any one of the plurality of printing parameters is generated;
obtaining, by the added user interface device, drawing rule information specially created for the added user interface device, the drawing rule information specifying a condition of which the added image is to be generated by the added user interface device;
determining, by the added user interface device, whether a current condition specified at least by the current processing status information obtained from the notification being sent from the primary user interface device satisfies the condition of which the added image is to be generated to generate a determination result;
generating the added image when the determination result indicates that the current condition satisfies the condition of which the added image is to be generated; and
sending notification from the added user interface device to the primary user interface device in response to the notification being received from the primary user interface device, the notification including current processing status information indicating whether the added image is generated.

6. The method of claim 5, wherein, when the added user interface device includes a plurality of added user interface devices, the sending notification from the primary user interface device to the added user interface device comprises:
determining an order of communicating the plurality of added user interface devices based on the order of which the plurality of added user interface devices are installed; and
sending the notification respectively to the plurality of added user interface devices in the determined order of communicating.

7. The method of claim 6, wherein, when the plurality of added user interface devices includes a first added user interface and a second added user interface, the method further comprising:
receiving, by the primary user interface device from the first adder user interface, the notification including current processing status information indicating whether the added image is generated by the first added user interface; and
sending, from the primary user interface device to the second added user interface device, the notification including current processing status information being updated using the current processing status information indicating whether the added image is generated by the first added user interface.

8. The method of claim 5, wherein, when the added image is generated, the method further comprising:
sending, from the added user interface device to the primary user interface device, the added image in addition to the notification;
combining, by the primary user interface device, an image generated by the primary user interface and the added image into a combined image; and
causing an output device to output the combined image when the primary user interface device determines that the combined image reflects all of the plurality of printing parameters.

9. A computer readable medium which stores a plurality of instructions which cause a computer to perform a method of print processing, the method comprising:
determining whether an added user interface device is installed onto the computer after installation of a primary user interface device onto the computer, the added user interfaced device configured to generate an added image;
obtaining a plurality of printing parameters from print settings information input by a user;
sending notification from the primary user interface device to the added user interface device, the notification including current processing status information indicating whether an image corresponding to any one of the plurality of printing parameters is generated;
obtaining, by the added user interface device, drawing rule information specially created for the added user interface device, the drawing rule information specifying a condition of which the added image is to be generated by the added user interface device;
determining, by the added user interface device, whether a current condition specified at least by the current processing status information obtained from the notification being sent from the primary user interface device satisfies the condition of which the added image is to be generated to generate a determination result;
generating the added image when the determination result indicates that the current condition satisfies the condition of which the added image is to be generated; and
sending notification from the added user interface device to the primary user interface device in response to the notification being received from the primary user interface device, the notification including current processing status information indicating whether the added image is generated.
